(19) United States
(12) Patent Application Publication
(10) Pub. No.: US 2009/0251572 A1
(43) Pub. Date: Oct. 8, 2009

(54) EFFICIENT WIDE-RANGE AND HIGH-RESOLUTION BLACK LEVEL AND OFFSET CALIBRATION SYSTEM

(76) Inventors: Chi-Shao Lin, Tainan (TW); Amit Mittra, Tainan (TW)

Correspondence Address: STOUT, UXA, BUYAN & MULLINS LLP, 4 VENTURE, SUITE 300, IRVINE, CA, 92618, US

(21) Appl. No.: 12/061,413

(22) Filed: Apr. 2, 2008

(51) Int. Cl. H04N 5/16

(52) U.S. Cl. 348/243

(57) ABSTRACT

A black level calibration (BLC) system is disclosed. A readout chain receives and amplifies dark signal, and generates corresponding digital output. A level integrator performs integration of calibration levels in multiple steps according to the digital output, thereby achieving wide calibration range.

### BACKGROUND OF THE INVENTION

1. Field of the Invention

The present invention relates to an image sensor, and more particularly to the black level calibration (BLC) in an image sensor. It also relates to any analog signal processing system associated with offset calibration.

2. Description of the Prior Art

Semiconductor based image sensors, such as charge-coupled devices (CCDs) or complementary metal-oxide-semiconductor (CMOS) sensors, are widely used in, for example, cameras or camcorders, to convert images of visible light into electronic signals that can then be stored, transmitted or displayed.

Due to the imperfections of electronic circuitry, leakage current (or dark signal) exists even when no light is received by the image sensor. This unwanted dark signal is accumulated along with desired data signal, and, for the worse, the dark signal is indistinguishable from the data signal. The accumulated dark signal consumes the image dynamic range and reduces image contrast, and thus degrades image quality. In order to suppress or correct the dark signal, a black level calibration (BLC) is thus needed. During the BLC period, a dark signal of one or more light-shielded pixels is collected as black level reference.

Moreover, the BLC very often also has to correct the offset of an analog readout chain (i.e., the total circuitry that receives and amplifies the signals read out of the image sensor, and finally outputs the digital equivalent). Particularly, as each pixel is manufactured smaller to accommodate more pixels in a given area, the minimized pixels each accumulates less signal, and high gain amplification is hence required, which results in quite wide range to perform the calibration. On the other hand, the BLC needs high resolution such that the calibration step is smaller than a digitized (or quantization) unit (such as the least significant bit (LSB) of an analog-to-digital converter (ADC)); otherwise, the calibration will unstably oscillate.

Accordingly, the BLC design typically faces the trade-off between the resolution and the range. Conventionally, to accomplish high resolution and wide range simultaneously, it usually involves circuitry that has substantially large size and power consumption. Therefore, a need has arisen to propose an efficient BLC design allowing small size and power consumption while achieving high resolution and wide range.

### SUMMARY OF THE INVENTION

In view of the foregoing, it is an object of the present invention to perform the integration of calibration levels in multiple steps, hence achieving wide calibration range. Moreover, the integrating step size may be gained up by the integrator gain, such that a DAC of smaller size and power consumption may be used to accomplish the integration.

According to one embodiment of the present invention, a readout chain receives and amplifies the dark signal from a photo detector and generates corresponding digital output. A level integrator performs integration of calibration levels in multiple steps according to the digital output, thereby achieving wide calibration range. In the embodiment, a digital-to-analog converter (DAC) generates and provides corresponding calibration voltages for the multiple steps to the level integrator.

### BRIEF DESCRIPTION OF THE DRAWINGS

FIG. 1 illustrates a functional block diagram of black level calibration (BLC) system according to one embodiment of the present invention;

FIG. 2 illustrates the level integrator of FIG. 1 according to one embodiment of the present invention; and

FIG. 3 shows an exemplary timing diagram of the level integrator.

### DETAILED DESCRIPTION OF THE INVENTION

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

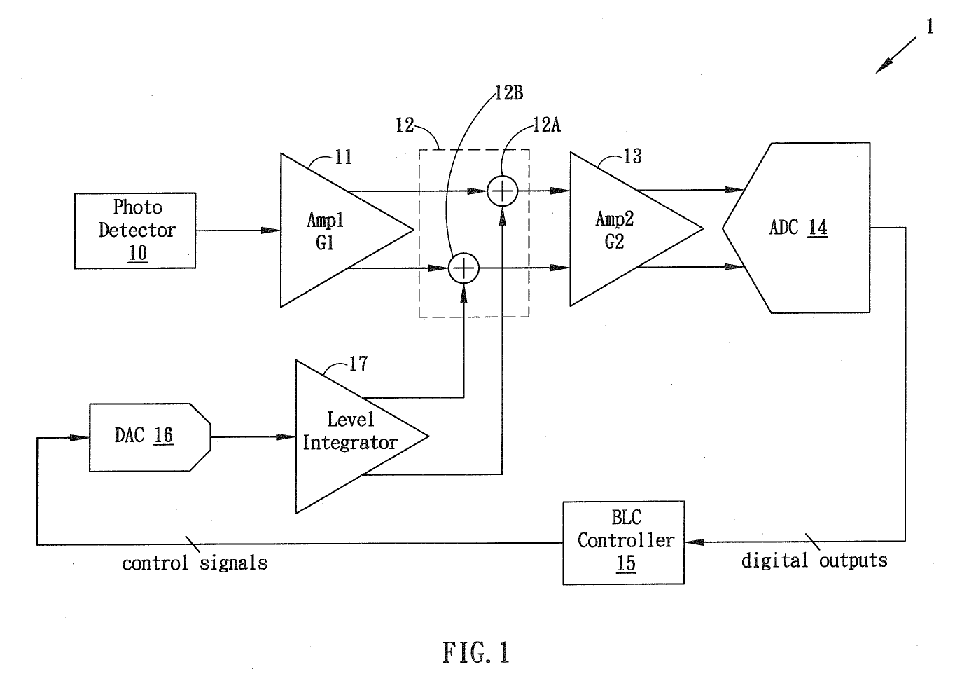

FIG. 1 illustrates a functional block diagram of black level calibration (BLC) system 1 according to one embodiment of the present invention. A photo detector 10 constitutes part of a semiconductor based image sensor, such as but not limited to a charge-coupled device (CCD) or a complementary metal-oxide-semiconductor (CMOS) sensor. The photo detector 10 converts photons into electronic signals. The photo detector 10 has dark signal V_{ds} whose magnitude typically varies from pixel to pixel, and is a function of, at least, integration time and temperature. In the BLC period, the dark signal of one or more light-shielded pixels is collected as black level reference. Average of a number of pixels is usually necessary to reduce temporal noise level.

The signal, particularly the dark signal during the BLC period, read out of the photo detector 10 is received and amplified by a first amplifier (or Amp1) 11. In the embodiment, the first amplifier 11 has a linear gain G₁, which represents the analog gain before a BLC injection node 12 (which will be discussed later in this specification). Further, the first amplifier 11 has offset voltage Vₒₛ₁, which represents the offset voltage accumulated up to the first amplifier 11 inclusive. The calibrated signal, particularly the calibrated dark signal during the BLC period, after the BLC injection node 12 is received and amplified by a second amplifier (or Amp2) 13. In the embodiment, the second amplifier 13 has a linear gain G₂, which represents the analog gain after the BLC injection node 12. Further, the second amplifier 13 has offset voltage Vₒₛ₂, which represents the offset voltage accumulated of the analog readout chain after the BLC injection node 12. In this specification, the term analog readout chain means the total circuitry that receives and amplifies the signals read out of the photo detector 10, and finally outputs the digital equivalent. In the embodiment, the first amplifier 11 and the second amplifier 13 are operational amplifiers (or op-amps) having fully-differential topology. In other words, each of the op-amps has both differential inputs and differential outputs. It is appreciated, however, by those skilled in the pertinent art that op-amps with topology other than the fully-differential topology may be well used instead.

The calibrated and amplified dark signal from the second amplifier 13 is digitized by an analog-to-digital converter (ADC) 14. The digital outputs from the ADC 14 are then fed to a BLC controller 15. The BLC controller 15 functions to, among others, compare the digital outputs from the ADC 14 with a target black level defined, for example, by a user. During the BLC period, the BLC controller 15 controls other portions of the BLC system 1 to arrive at the target black level. The implementing circuitry of the BLC controller 15 may be found, for example, in U.S. Pat. No. 7,259,787, the disclosure of which is hereby incorporated by reference.

Moreover, according to the embodiment of the present invention, the BLC controller 15 uses one or more schemes (which will be discussed later) to controllably command a digital-to-analog converter (DAC) 16 and hence a level integrator 17 to provide a negative feedback to the analog readout chain, thereby calibrating the black level. The differential outputs of the level integrator 17 are inputted to two adders 12A and 12B respectively. Specifically, the first adder 12A receives one output of the first amplifier 11 and one output of the level integrator 17; and the second adder 12B receives another output of the first amplifier 11 and another output of the level integrator 17. It is noted that the outputs of the level integrator 17 may be configured to be added to the adders 12A/12B, or alternatively may be configured to be subtracted from the adders 12A/12B. In the embodiment, the adders 12A/12B are configured to be located between the first amplifier 11 and the second amplifier 13. However, the location of the adders 12A/12B (i.e., the BLC injection node 12) is not limited to this configuration. Further, the number of amplifiers used in the analog readout chain may be one or more.

Prior to addressing the schemes and the level integrator 17, an exemplary scenario with accompanied Table 1 is discussed below to appreciate the trade-off between the resolution and the range, and between the gains G₁ and G₂.

TABLE 1

| V_{ds} | Vₒₛ_{_{—}}_{d} | G₁ | Vₒₛ₁ | G₂ | Vₒₛ₂ | V_{ds}_{_{—}}_{cal} | Vₒₛ_{_{—}}_{cal} |
|---|---|---|---|---|---|---|---|
| 3 mV | ±3 mV | 20 | ±10 mV | 4 | ±10 mV | 60 mV | ±72.5 mV |

where
V_{ds}_{_{—}}_{cal}=G₁. V_{ds}, dark signal to be calibrated
Vₒₛ_{_{—}}_{cal}=G₁. Vₒₛ_{_{—}}_{d}+Vₒₛ₁+Vₒₛ₂/G₂, signal chain offset to be calibrated

For a given overall gain (i.e., G₁. G₂), the combination of a larger G₁ and a smaller G₂ will need a BLC system that requires larger range (but relaxed resolution requirement or more noise tolerance); alternatively, the combination of a smaller G₁ and a larger G₂ will need a BLC system that demands more preciseness/high resolution (but relaxed range requirement). For the exemplary scenario, the worst case for calibration range will be from −72.5 mv to 132.5 mV (=60 mV+72.5 mV), which is approximately equivalent to about 420 digital number (DN) when the ADC input digitization range is 2V. Accordingly, a 9-bit DAC will minimally satisfy both the range and the precision requirement. Nevertheless, a 10-bit DAC will be more appropriate as the calibration step is smaller than the least significant bit (LSB) (approximate 490 μV) of the ADC.

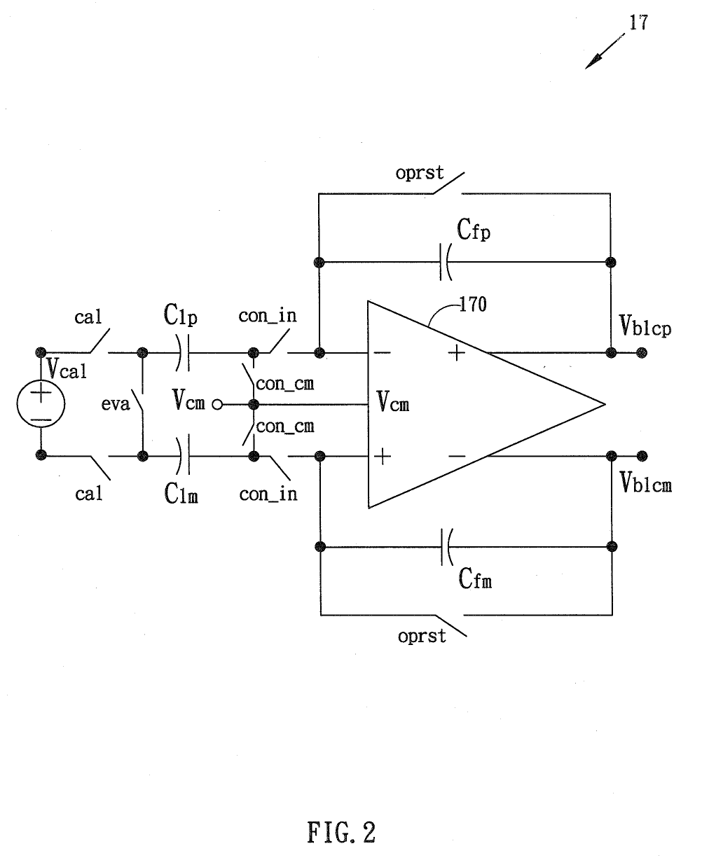

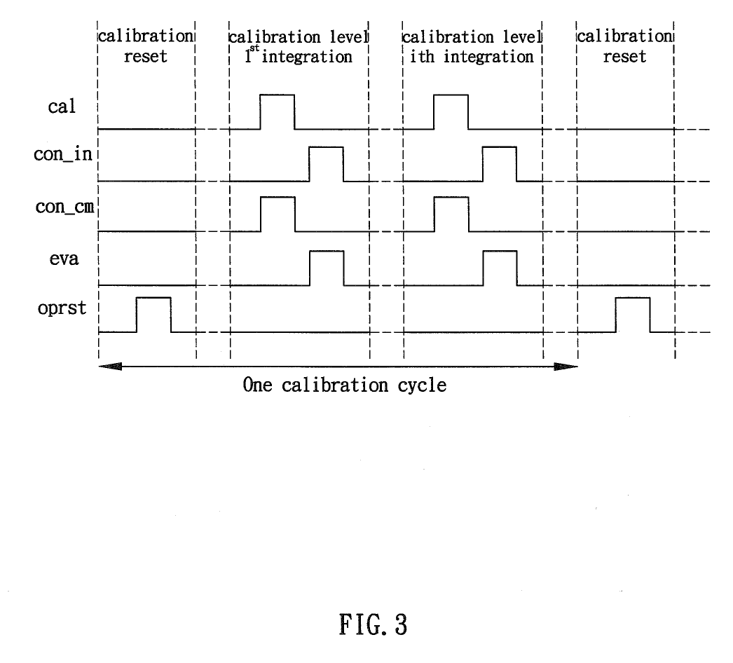

FIG. 2 illustrates the level integrator 17 of FIG. 1 according to one embodiment of the present invention, and FIG. 3 shows an exemplary timing diagram of the level integrator 17. In the embodiment, the level integrator 17 includes an operational amplifier (or op-amp) 170 having fully-differential topology. In other words, the op-amp 170 has both differential inputs and differential outputs. It is appreciated, however, by those skilled in the pertinent art that op-amp with topology other than the fully-differential topology may be well used instead. A first feedback capacitor C_{fp} is connected between the non-inverting output V_{blcp} and the inverting input; and a second feedback capacitor V_{fm} is connected between the inverting output V_{blcm} and the non-inverting input. Reset switches (oprst) cross and connect at ends of the feedback capacitors C_{fp} and C_{fm}, respectively. The reset switches (oprst) close to erase the charge in the feedback capacitors C_{fp} and C_{fm} only before another integration begins.

Still referring to FIG. 2, a calibration voltage V_{cal} is provided and generated by the DAC 16 (FIG. 1), which is under control of the control signals from the BLC controller 15 (FIG. 1). One end of the calibration voltage V_{cal} is connected to the inverting input of the op-amp 170 via a first branch that includes a calibration switch (cal), a first input capacitor C₁ₚ and an input switch (con_in), connected in series. Another end of the calibration voltage V_{cal} is connected to the non-inverting input of the op-amp 170 via a second branch that includes another calibration switch (cal), a second input capacitor C₁ₘ and another input switch (con_in), connected in series. A common-mode voltage V_{cm} is connected to the interconnection of the first input capacitor C₁ₚ and the input switch (con_in) via a common-mode switch (con_cm); and the common-mode voltage V₁ₘ is also connected to the interconnection of the second input capacitor C₁ₘ and the input switch (con_in) via another common-mode switch (con_cm). An evaluation switch (eva) is connected between the first branch and the second branch.

The integration operation primarily includes two steps. In the first step, the calibration switches (cal) and the common-mode switches (con_cm) are closed (while other switches open), such that the calibration voltage V_{cal} is sampled and the associated charge is then stored in the first input capacitor C₁ₚ and the second input capacitor C₁ₘ respectively. Subsequently, in the second step, the input switches (con_in) and the evaluation switch (eva) are closed (while other switches open), such that the charges stored in the first input capacitor C₁ₚ and the second input capacitor C₁ₘ are transferred to the feedback capacitors C_{fp} and C_{fm} respectively, thereby generating the integrating output.

According to the embodiment of the present invention, the BLC controller 15 determines an appropriate scheme to command the DAC 16 and the level integrator 17. For example, the level integrator 17 under control of the BLC controller 15 may accomplish the integration in one step using a 10-bit DAC 16, as shown in the scheme 1 in Table 2.

TABLE 2

| | | | | Maximum | |
|---|---|---|---|---|---|
| | | | | gain | |
| | | | No. of | (C₁/C₁) | Minimum |
| | | | calibration | of | no. of bits |
| | Calibration | Calibration | steps to | integrator | required |
| Scheme | Range | Precision | integrate | step | for DAC |
| 1 | 250 mV | 400 μV | 1 | 1 | 10 |
| 2 | 250 mV | 400 μV | 4 | 1 | 8 |
| 3 | 250 mV | 400 μV | 4 | 2 | 7 |

Alternatively, the level integrator 17 may accomplish the integration in four steps using a smaller 8-bit DAC 16, as shown in the scheme 2. Compared to the scheme 1, the scheme 2 accomplishes the integration in multiple steps with each step having a range smaller than the total range; and utilizes a smaller DAC 16 having smaller power consumption. In general, the differential outputs of the level integrator 17 may be expressed as follows:

$${V}_{blcp} = {V}_{cm} - \frac{{G}_{blc}}{2} \cdot \sum {V}_{cal} ( i )$$

where V_{cal}(i) represents the calibration voltage for the i-th step generated by the DAC 16, that is further controlled by the BLC controller 15;

$${V}_{blmp} = {V}_{cm} + \frac{{G}_{blc}}{2} \cdot \sum {V}_{cal} ( i )$$

$${G}_{blc} = \frac{{C}_{1}}{{C}_{f}}$$

where C₁ represents C₁ₚ or C₁ₘ, and C_{f} represents C_{fp} or C_{fm}.

According to another aspect of the embodiment of the present invention, the step size not only can be changed by the DAC 16 as described above, but also can be changed by the integrator gain G_{bic} of the level integrator 17. For example, in the scheme 3 of Table 2, the level integrator 17 accomplishes the integration in four steps as in the scheme 2. Nevertheless, as the integrating step size is gained up by the integrator gain G_{blc}(=2), a smaller 7-bit DAC 16 may be used to accomplish the integration. Accordingly, the embodiment of the present invention provides increased flexibility in performing calibration: the BLC controller 15 may choose a larger calibration step size to speed up convergence while still sway from the target, and may reduce step size while close to the target for better resolution and stability.

According to the embodiment of the present invention, integration of calibration levels may be performed in multiple steps, hence achieving wide calibration range. As the calibration circuit needs not to achieve target range in single step, it can be implemented with a smaller size and smaller power consumption, without sacrificing the resolution.

Although specific embodiments have been illustrated and described, it will be appreciated by those skilled in the art that various modifications may be made without departing from the scope of the present invention, which is intended to be limited solely by the appended claims.

What is claimed is:

1. An analog signal processing system, comprising:
a readout chain that receives and amplifies dark signal, and generates corresponding digital output; and
a level integrator that performs integration of calibration levels in multiple steps according to the digital output, thereby achieving wide calibration range.

2. The analog signal processing system of claim 1, further comprising a digital-to-analog converter (DAC) that generates and provides corresponding calibration voltages for the multiple steps to the level integrator.

3. The analog signal processing system of claim 2, wherein the readout chain comprises:
a first amplifier that receives and amplifies the dark signal;
at least one adder that receives output of the first amplifier and output of the level integrator; and
a second amplifier that receives and amplifies output of the adder.

4. The analog signal processing system of claim 3, wherein the readout chain further comprises:
an analog-to-digital converter (ADC) that digitizes output of the second amplifier.

5. The analog signal processing system of claim 4, further comprising:
a BLC controller that controls the DAC and the level integrator according to digital output of the ADC.

6. The analog signal processing system of claim 1, wherein the level integrator comprises:
an amplifier;
at least one feedback capacitor connected between output and input of the amplifier;
at least one input capacitor connected to the input of the amplifier via an input switch; and
at least one calibration switch connected between the calibration voltage and the input capacitor;
wherein the input capacitor is charged by the calibration voltage via the closed calibration switch, and subsequently charge of the input capacitor is transferred to the feedback capacitor via the closed input switch.

7. A black level calibration (BLC) system for an image sensor, comprising:
a readout chain that receives and amplifies dark signal from a photo detector and generates corresponding digital output; and
a level integrator that performs integration of calibration levels in multiple steps according to the digital output, thereby achieving wide calibration range.

8. The BLC system for an image sensor of claim 7, further comprising a digital-to-analog converter (DAC) that generates and provides corresponding calibration voltages for the multiple steps to the level integrator.

9. The BLC system for an image sensor of claim 8, wherein the readout chain comprises:
a first amplifier that receives and amplifies the dark signal from the photo detector;
at least one adder that receives output of the first amplifier and output of the level integrator; and
a second amplifier that receives and amplifies output of the adder.

10. The BLC system for an image sensor of claim 9, wherein the readout chain further comprises:
an analog-to-digital converter (ADC) that digitizes output of the second amplifier.

11. The BLC system for an image sensor of claim 10, further comprising:
a BLC controller that controls the DAC and the level integrator according to digital output of the ADC.

12. The BLC system for an image sensor of claim 7, wherein the level integrator comprises:
an amplifier;
at least one feedback capacitor connected between output and input of the amplifier;
at least one input capacitor connected to the input of the amplifier via an input switch; and
at least one calibration switch connected between the calibration voltage and the input capacitor;
wherein the input capacitor is charged by the calibration voltage via the closed calibration switch, and subsequently charge of the input capacitor is transferred to the feedback capacitor via the closed input switch.

13. A black level calibration (BLC) system for an image sensor, comprising:
a photo detector;
a first amplifier that receives and amplifies dark signal from the photo detector;
at least one adder that receives output of the first amplifier at one input end;
a second amplifier that receives and amplifies output of the adder;
an analog-to-digital converter (ADC) that digitizes output of the second amplifier;
a BLC controller that generates control signal according to comparison of the digital output of the ADC and a target;
a digital-to-analog converter (DAC) that generates and provides corresponding calibration voltages for multiple steps under control of the BLC controller;
a level integrator that performs integration of calibration levels in the multiple steps by receiving the calibration voltages from the DAC, thereby achieving wide calibration range, wherein output of the level integrator is fed to the adder at another input end.

14. The BLC system for an image sensor of claim 13, wherein the level integrator comprises:
an amplifier;
at least one feedback capacitor connected between output and input of the amplifier;
at least one input capacitor connected to the input of the amplifier via an input switch; and
at least one calibration switch connected between the calibration voltage and the input capacitor;
wherein the input capacitor is charged by the calibration voltage via the closed calibration switch, and subsequently charge of the input capacitor is transferred to the feedback capacitor via the closed input switch.

15. The BLC system for an image sensor of claim 14, further comprising:
at least one reset switch that crosses and connects at ends of the feedback capacitor.

16. The BLC system for an image sensor of claim 15, further comprising:
at least one common-mode switch connected between a common-mode voltage and an intersection of the input capacitor and the input switch.

17. The BLC system for an image sensor of claim 14, wherein the amplifier of the level integrator has a fully-differential topology.

18. The BLC system for an image sensor of claim 13, wherein the level integrator has a gain greater than one.

19. The BLC system for an image sensor of claim 13, wherein the photo detector is a semiconductor based image sensor.

20. The BLC system for an image sensor of claim 19, wherein the semiconductor based image sensor is a CCD or CMOS sensor.
